(19) United States
(12) Patent Application Publication
(10) Pub. No.: US 2007/0093204 A1
(43) Pub. Date: Apr. 26, 2007

(54) Control system

(76) Inventor: Dwayne Kincard, St. Leonard, MD (US)

Correspondence Address: ALUN L. PALMER, PATENT AGENT, 4300 PINEY CHURCH ROAD, WALDORF, MD, 20602, US

(21) Appl. No.: 10/892,317

(22) Filed: Jul. 16, 2004

(51) Int. Cl. H04B 7/185; H04B 1/06

(52) U.S. Cl. 455/13.3; 455/352

(57) ABSTRACT

A system for sending uplink control signals to antennas and receiving downlink signals therefrom, where the uplink signals may be used to control antenna position and operate antenna switches and the like, and the downlink signals may indicate antenna position, the uplink signals being in the form of digital signals having two voltage levels within the range of a DC supply superimposed on the RF signals on the antenna feeder, and the downlink signals being digital signals in the form of changes in the DC current on the feeder, generated by a load having two resistance values.

### BACKGROUND OF THE INVENTION

1. Field of the Invention

The invention relates to a system for sending uplink control signals to antennas and receiving downlink signals therefrom. More particularly, the invention relates to a system where the uplink signals may be used to control antenna position and operate antenna switches and the like, and the downlink signals may indicate antenna position.

2. Discussion of the Background

It is relatively common, for example in amateur radio, to mount several antennas on a single mast or tower. Each of these antennas has to be connected via a length of high frequency feed line, such as a coaxial cable. Loss in these cables is proportional to length as well as to frequency. This can be mitigated by selecting low loss types of cables, but at significant cost. Directional antennas are often used to provide significant gain, but must then be rotatable to cover all directions. A remote antenna switch may be used to select the antenna in use, thereby consolidating the various coaxial cables, a single rotator may he use to rotate all the directional antennas in unison. However, typically, the antenna switch and the rotator each require separate power cables and control cables of their own. It is not uncommon for a rotator cable to have seven or eight wires. The height of the tower may be from, say 30 to 120 feet, and may be located at some distance from the radio equipment. The cost and complexity of cabling may therefore be very significant, even if a remote antenna switch is employed.

It is known to supply DC power for accessories on coaxial. cables, for example to operate a masthead preamplifier. This eliminates the need to have separate power wiring as well as a coaxial cable for the antenna. Separation of the direct current and radio frequency components can be easily obtained using a suitable blocking capacitor. Rotators and antenna switches could be powered in the same way, but normally separate control cables would also be required.

Van Amesfoort discloses a signaling scheme in U.S. Pat No. 6,075,970 in which a supply voltage of either 13 or 17 volts DC is sent over the feed line to select vertical or horizontal polarization, such as by selecting separate Low-Noise Convertors (LNCs) connected to vertical and horizontal feeds of a satellite TV dish. In this scheme the presence or absence of a separate 22 kHz AC signal is used to select one of two bands, such as X-band and L-band for satellite TV, and also bursts of the 22 kHz signal are used to send digital commands to the dish, but no telemetry is provided from the dish to the receiver. The only signal sent from the dish to the receiver is the RF output from one or the other LNC.

The signaling scheme of Van Amesfoort is relatively complex, as it uses both DC signals and an audio tone. It also does not provide for any indication of the status of the remotely mounted antenna system, which includes only a single fixed antenna dish. A need exists, not only in radio installations, but also in other remote installations, for example with remote controlled TV cameras, for a simple two-way control system that can be combined with a remote power supply that can be superimposed on a radio frequency feed line such as a coaxial cable.

### SUMMARY

A system for sending uplink control signals to antennas and receiving downlink signals therefrom, where the uplink signals may be used to control antenna position and operate antenna switches and the like, and the downlink signals may indicate antenna position, the uplink signals being in the form of digital signals having two voltage levels within the range of a DC supply superimposed on the RF signals on the antenna feeder, and the downlink signals being digital signals in the form of changes in the DC current on the feeder, preferably generated by a load having two resistance values, as further discussed and as shown in the drawings

### BRIEF DESCRIPTION OF THE DRAWINGS

FIG. 1 is a view of a system according to a preferred embodiment of the invention.

FIG. 2 is a view of an uplink waveform according to a preferred embodiment of the invention.

FIG. 3 is a partial block diagram of a remote unit according to a preferred embodiment of the invention, showing demodulation of the control signals.

FIG. 4 is a partial block diagram of a remote unit according to a preferred embodiment of the invention, showing modulation of the load current.

FIG. 5. is a partial block diagram of a control unit according to a preferred embodiment of the invention, showing modulation of the DC supply voltage.

FIG. 6. is a partial block diagram of a control unit according to a preferred embodiment of the invention, showing demodulation of the downlink telemetry.

FIG. 7. is a block diagram showing a remote antenna switch.

FIG. 8 is a view of an downlink waveform according to a preferred embodiment of the invention.

### DETAILED DESCRIPTION

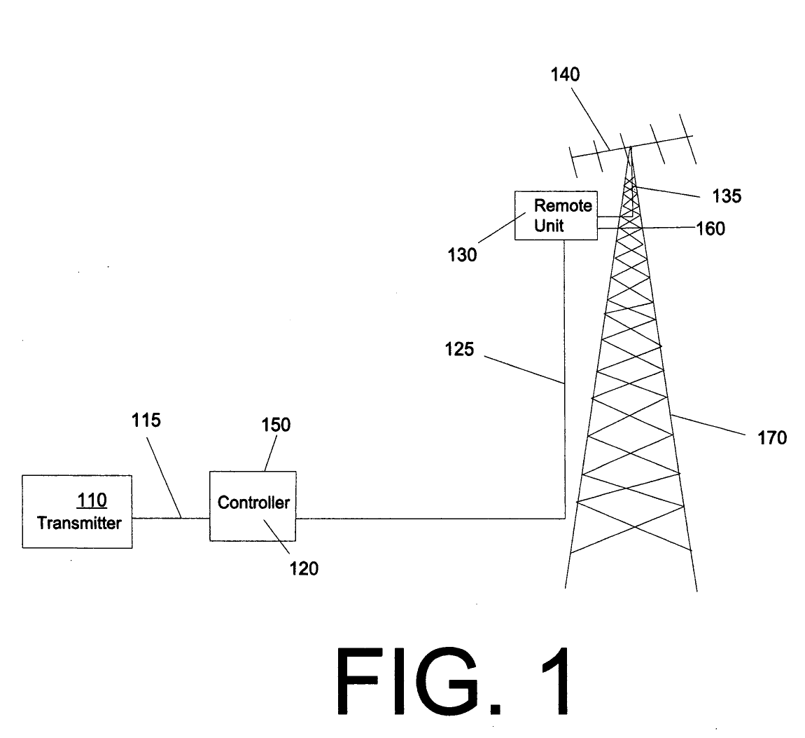

FIG. 1 is a view of a system according to a preferred embodiment of the invention. A transmitter 110 is connected via a short feed line 115 to a controller 120, which is in turn connected via feed line 125 to remote unit 130. Control inputs 150 are applied to control unit 120. A further short feed line connects remote unit 130 to an antenna 140 and provides control signals at output 160. Uplink signals from the controller 120 are recovered by the remote unit 130, and may for example be used to control rotation of antenna 140 and/or to control an antenna switch to select between a plurality of antennas. For satellite working, i.e. for OSCAR satellites (Orbiting Satellites Carrying Amateur Radio), separate rotators may be simultaneously controlled for azimuth and elevation.

Transmitter 110 may be a mere transmitter, or preferably a transceiver combining transmit and receive functions, or a receiver may be substituted therefor without departing from the scope of the invention. In addition, control unit 120 may optionally be integrated into the transmitter or transceiver 110. More generally, the transmitter 110 and antenna 140 could be replaced with other types of electronic equipment. For example the antenna could be replaced with a TV camera and the transmitter with a TV monitor. The feed lines would typically be coaxial cable for radio frequency use, but other types of transmission line could conceivably be used.

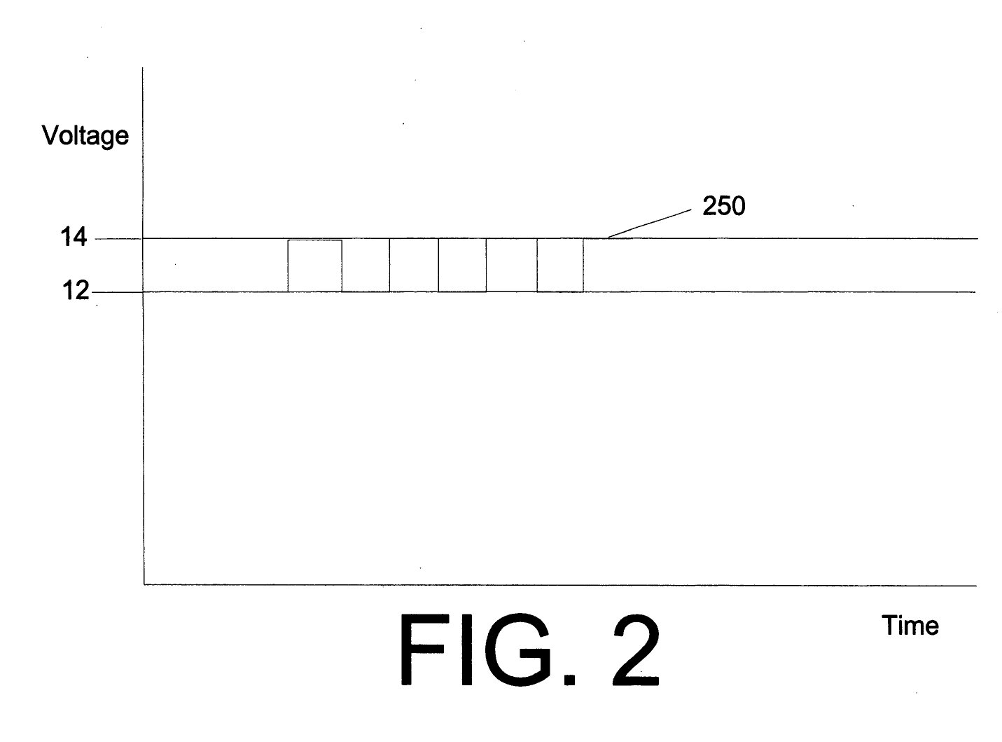

The uplink waveform is shown at 250 in FIG. 2. The upper and lower limits of the waveform are shown as 12 and 14 volts. It should be understood that these levels are exemplary only, but would be appropriate for equipment designed to run from a nominal 12 volt power supply, as is the case for most amateur radio equipment and much other communications equipment. Batteries that have a nominal voltage of 12 volts actually have a discharged voltage of around 12 volts, and normally charge up to around 14 volts, and therefore regulated ‘12 volt’ DC power supplies for communications use are typically in fact designed to output 13.8 volts. Consequently, most ‘12 volt’ communications equipment is designed for a working voltage range of at least 12 to 14 volts. This means that a digital signal where the two logic levels are 12 and 14 volts can be used both to power such equipment and to convey information, in this case control signals. It will be apparent to those skilled in the art that, for example, different logic levels would be necessary in a 24 volt system.

To send downlink signals in the system of the present invention, the power supply current is optionally modulated. This can be achieved by switching a DC load, such as a resistor. This produces only a relative change in the DC current, which is of course also affected by any normal load current fluctuations for other reasons (e.g. starting and stopping an antenna rotator, etc). The uplink waveform 850 is shown in FIG. 8. When the DC load is applied the current has the lower value ‘L’ and when the DC load is not applied the current has the higher value ‘H’.

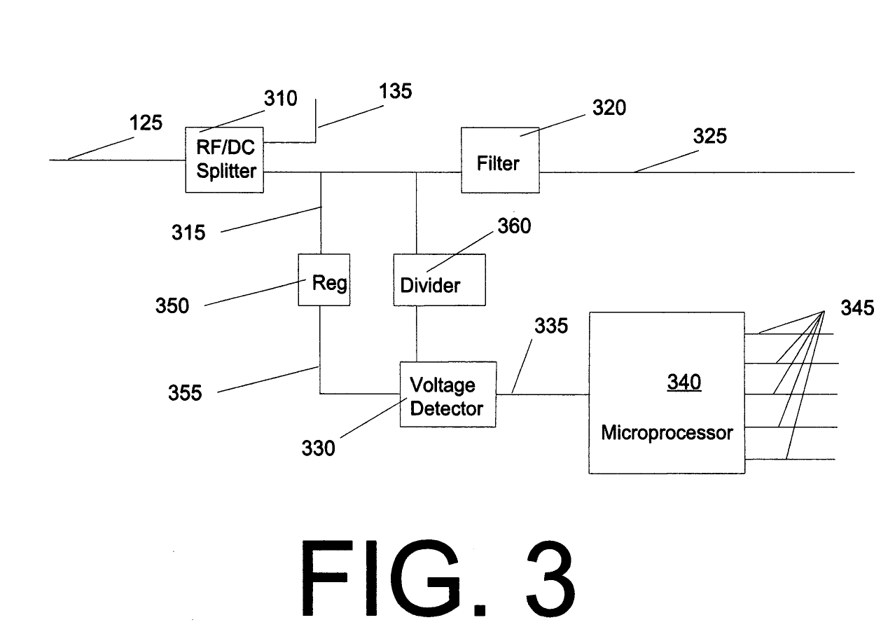

FIG. 3 shows part of a remote unit 130 according to a preferred embodiment of the invention. Feed line 125 carries both an RF signal and DC from transmitter 110 and control unit 120, which are fed into an RF/DC splitter 310. From there the RF is fed via feed line 135 to antenna 140. The DC voltage 315 from splitter 310 is filtered by filter 320 to provide a DC supply voltage 325, which can then be used to power antenna rotators, a remote antenna switch, preamplifiers and/or any other accessories remotely located at the antenna 140, or indeed at any other location connected to a control unit 120 by a high frequency feed line. The DC output 315 of the splitter 310 is also supplied to a voltage regulator 350 and via a voltage divider 360 to a voltage comparator 330. The regulated voltage output 355 from the regulator 350 may be typically 6 volts, but it will be appreciated that other voltages nay be used. The voltage divider 360 reduces the voltage 315 into an appropriate range so that it can be demodulated by the comparator 330, which is supplied from the regulator 350. This arrangement enables the comparator 330 to run from a stabilized voltage 355. The output voltage 335 from the voltage comparator 330 is then fed into a microprocessor 340, which in turn takes the binary signal 335 and generates control outputs 345 in accordance with a stored program. The control outputs 345 may be used to control antenna rotators, remote antenna switches, preamplifiers, or any other devices. Suitable driver circuitry may of course be used to increase the amplitude of the various control outputs 345 to drive the controlled devices, as is well known in the art.

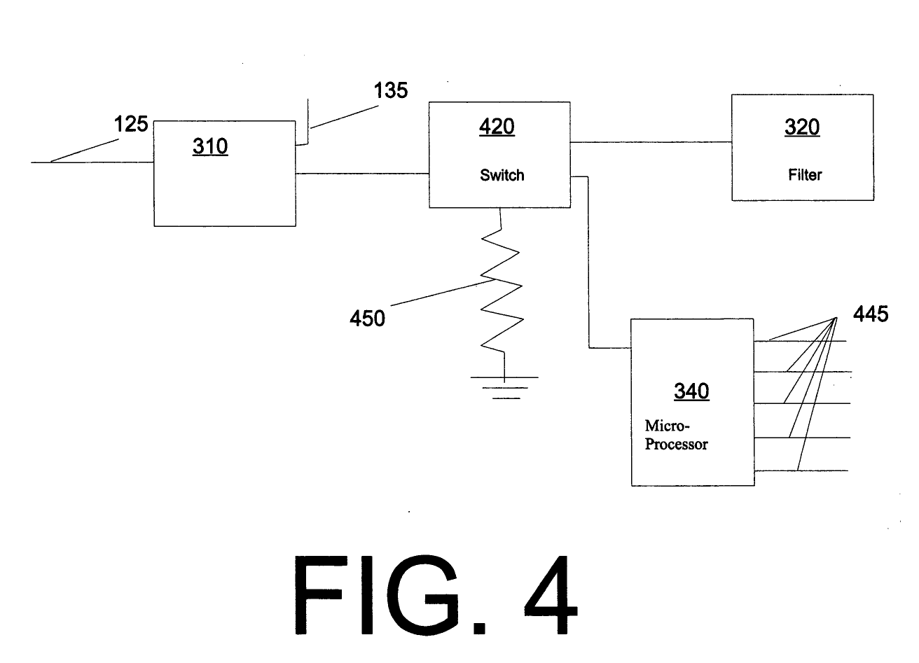

FIG. 4 is a further partial diagram of the same remote unit 130 according to this preferred embodiment of the invention, showing modulation of the load current to carry telemetry from the antenna 140 to control unit 120. Telemetry signals 445 may be derived from such parameters as antenna rotator position and/or remote antenna switch selection, and are fed into microprocessor 340. In response to a stored program, microprocessor 340 sends a serial binary signal to switch 420, which connects or disconnects a load 450. The switch 420 is placed between the RF/DC splitter 310 and the filter 320. Switching the load 450 modulates the DC current.

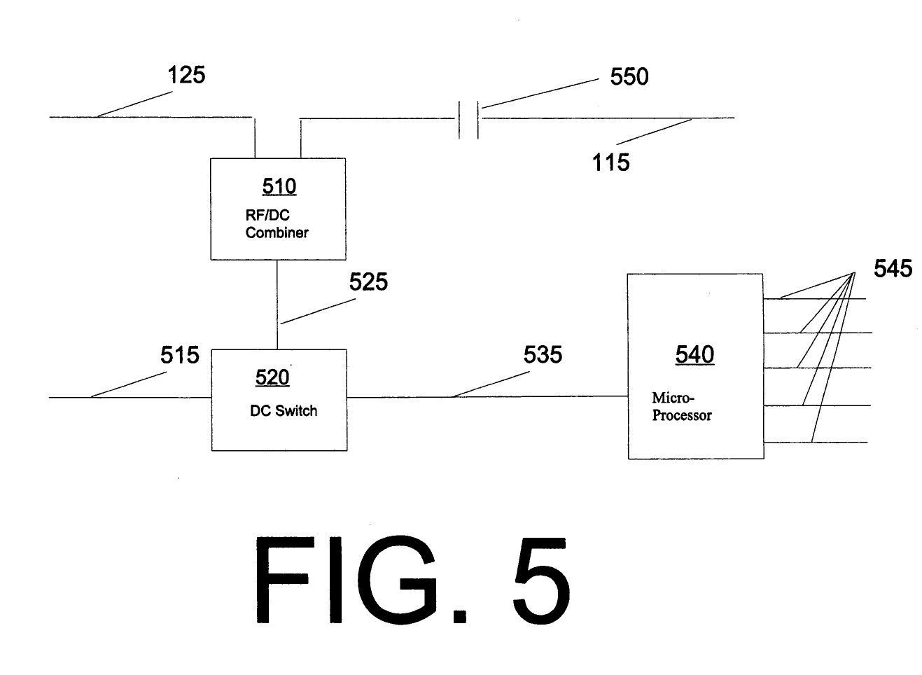

FIG. 5. is a partial block diagram of a control unit 120 according to a preferred embodiment of the invention, showing modulation of the DC supply voltage to carry control signals. RF from the transceiver 110 on feed line 115 passes through DC blocking capacitor 550 to RF/DC combiner 510 and thence via feed line 125 to the remote unit 130. Control signals 545 are input to microprocessor 540, which produces a serial binary output 535 in accordance with a stored program that in turn controls DC switch 520. A source of DC power 515, such as that obtained from a nominally 12 volt regulated power supply, is also applied to the DC switch 520. The DC switch 520 modulates the DC voltage at 525 between, say approximately 12 and 14 volts in response to the binary signal 535, and RF/DC combiner 510 combines the modulated DC voltage 525 with the RF on feed line 115 to produce a signal on feed line 125 that includes both RF and modulated DC power.

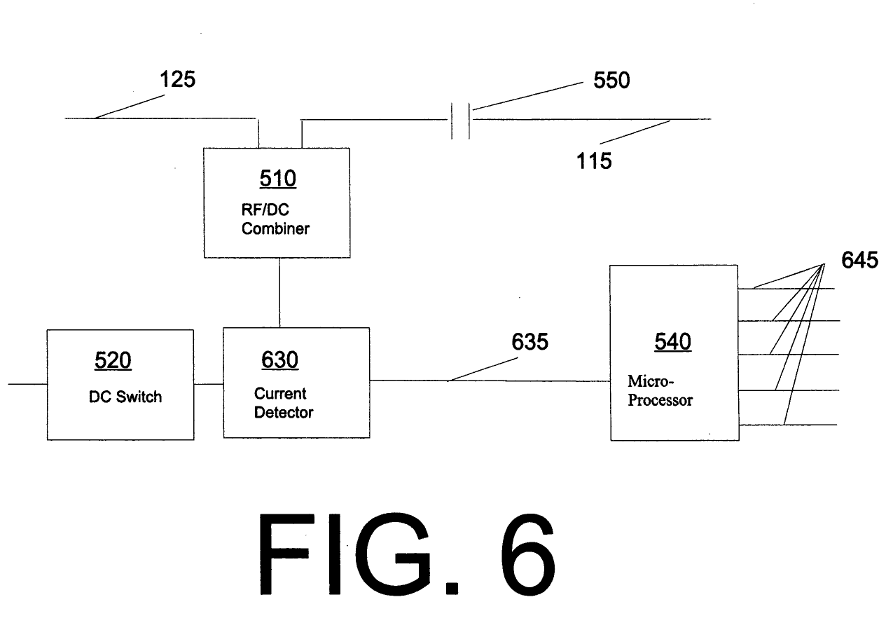

FIG. 6. is a partial block diagram of a control unit 120 according to a preferred embodiment of the invention, showing demodulation of the downwind telemetry. This shows a current detector 630 placed in between RF/DC combiner 510 and DC switch 520. This detects changes in the DC current recovered from the RF/DC combiner 510 and outputs a serial binary signal 635 to microprocessor 540, which, in response to a stored program, outputs separate telemetry outputs 645, corresponding to telemetry inputs 445 in FIG. 4.

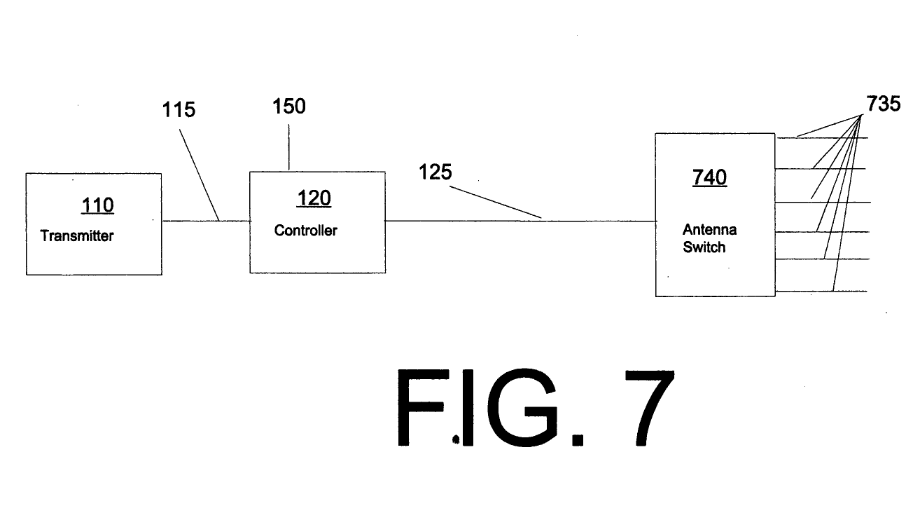

FIG. 7. is a block diagram showing a remote antenna switch 740. A transmitter 110 is connected via a short feed line 115 to a controller 120, which is in turn connected via feed line 125 to remote antenna switch 740. Control inputs 150 are applied to control unit 120 to control antenna switch 740 to select between a plurality of antennas connected to terminals 735.

As will readily be appreciated by those skilled in the art, numerous modifications and variations of the above embodiments of the present invention are possible without departing from the scope of the invention.

1. A method for remote control, comprising the steps of:
providing a high frequency feed line from a control unit to a remote installation;
imposing a DC voltage on said high frequency feed line;
modulating said DC voltage with control data such that an amplitude of said DC voltage remains within a working range for a standard DC power supply, and
recovering said control data at said remote installation.

2. The method according to claim 1, further comprising the steps of:
modulating a DC current with telemetry data relating to at least one parameter of said remote installation, said DC current associated with said DC voltage; and
recovering said telemetry data at said control unit.

3. The method according to claim 2, further comprising the steps of:
said remote installation comprises at least one accessory powered by said DC voltage; and
controlling said at least one said accessory by said control data.

4. The method according to claim 3, further comprising the step of:
rotating an antenna in response to said control data.

5. The method according to claim 3, further comprising the step of:
selecting an antenna from a plurality of antennas in response to said control data.

6. The method according to claim 3, wherein:
said parameter comprises a displacement of an antenna at said remote installation.

7. The method according to claim 3, wherein:
said parameter comprises an indication of an antenna selected at said remote installation.

8. A control unit comprising:
means for imposing a DC voltage on a high frequency communication signal; and
means for modulating said DC voltage with control data such that an amplitude of said DC voltage remains within a working range for a standard DC power supply.

9. The control unit according to claim 8, further comprising:
means for demodulating a DC current carrying telemetry data relating to at least one parameter, said DC current associated with said DC voltage.

10. A remote unit comprising:
means for separating a superimposed DC voltage from a high frequency communication signal; and
means for demodulating control data carried by said DC voltage, where an amplitude of said DC voltage remains within a working range for a standard DC power supply.

11. The remote unit according to claim 10, further comprising:
means for modulating a DC current with telemetry data relating to at least one parameter, said DC current associated with said DC voltage.

12. The remote unit according to claim 11, wherein said remote unit:
is configured to supply said DC voltage to at least one accessory; and
comprises means for controlling said at least one said accessory by said control data.

13. The remote unit according to claim 12, further comprising:
means for rotating an antenna in response to said control data.

14. The remote unit according to claim 12, further comprising:
means for selecting an antenna from a plurality of antennas in response to said control data.

15. The remote unit according to claim 12, wherein:
said parameter comprises a displacement of an antenna.

16. The remote unit according to claim 12, wherein:
said parameter comprises an indication of an antenna selected.

17. A composite waveform, comprising:
a high frequency signal carrying communications information;
a DC voltage superimposed on said high frequency signal;
control data modulated on said DC voltage, such that an amplitude of said DC voltage remains within a working range for a standard DC power supply.

18. The waveform according to claim 17, wherein:
said control data comprises a desired position of an antenna.

19. The waveform according to claim 17, wherein:
said control data comprises antenna selection data.

20. The waveform according to claim 17, wherein:
a DC current is modulated with telemetry data relating to at least one parameter of a remote installation, said DC current associated with said DC voltage.

21. The waveform according to claim 20, wherein:
said parameter comprises a displacement of an antenna at said remote installation.

22. The waveform according to claim 20, wherein: said parameter comprises an indication of an antenna selected at said remote installation.
